(19) United States
(12) Patent Application Publication
(10) Pub. No.: US 2014/0029435 A1
(43) Pub. Date: Jan. 30, 2014

(54) QUALITY OF SERVICE HANDLING IN PACKET CORE AND RADIO NETWORKS

(71) Applicants: Hans Mattsson, Bollebygd (SE); Reiner Ludwig, Hurtgenwald (DE); Paul Schliwa-Bertling, Ljungsbro (SE)

(72) Inventors: Hans Mattsson, Bollebygd (SE); Reiner Ludwig, Hurtgenwald (DE); Paul Schliwa-Bertling, Ljungsbro (SE)

(73) Assignee: TELEFONAKTIEBOLAGET L M ERICSSON (PUBL), Stockholm (SE)

(21) Appl. No.: 14/009,941

(22) PCT Filed: Apr. 7, 2011
(86) PCT No.: PCT/EP2011/055457

§ 371 Date: Oct. 4, 2013

(51) Int. Cl. H04W 28/02

(52) U.S. Cl. CPC H04W 28/0252
USPC 370/236

(57) ABSTRACT

There is provided a serving node S) comprising processing means (CTRL_U1; MEM_{—}1) and an interface unit (INT_U1) and a method for such a serving node, the serving node being adapted for participating in a network requested secondary PDP context activation procedure, the processing means being adapted for: —receiving (91) an initiate PDP context activation request signal from a gateway node (G). The serving node is also adapted for—determining (92A) whether the user entity supports network requested dedicated bearers; and if not the case; —without engaging in signalling with the user entity, transmitting (93) an initiate PDP context activation response signal indicating the network requested secondary PDP context activation has been accepted; and—transmitting (95) a create PDP context request signal to the gateway node. The Serving node may be adapted to further: if interacting with a GERAN radio node; —receiving (96) a create PDP context response signal from the gateway node (G), with a negotiated quality of service; —transmitting (97) a create BSS packet flow context request signal to the user entity, optionally comprising an indication, that the user entity supports no network requested dedicated bearer. Moreover, there is provided a radio node and a method for a radio node.

### TECHNICAL FIELD

This invention relates to methods and means for setting up and controlling packet transmission in packet core and radio networks. More particularly, the invention relates to providing various quality of service options in packet core and radio networks.

### BACKGROUND

When a mobile terminal initiates a service under GPRS (General Packet Radio System), the mobile terminal first attaches and then activates a PDP context. This allocates a PDP context data structure in the serving node (SGSN) that the subscriber is currently visiting and the gateway node (GGSN) serving the subscriber's access point. The data structure comprises
a subscriber's IP address;
a subscriber's IMSI;
a subscriber's tunnel Endpoint ID (TEID) at the GGSN;
a subscriber's tunnel Endpoint ID (TEID) at the SGSN.

The Tunnel Endpoint ID (TEID) is a number allocated by the GSN which identifies tunneled data related to a particular PDP context. Several PDP contexts may use the same IP address. A Secondary PDP Context Activation procedure may be used to activate a PDP context while reusing the PDP address and other PDP context information from an already active PDP context. This is useful when several applications, which are running on a mobile terminal, are making use of respective different Internet services each requiring a specific QoS (Quality of Service) profile. In GPRS there exist many possibilities for using PDP contexts.

PDP contexts are also used for a recent generation of packet core networks, Evolved Packet Core (EPC), which caters for the LTE (Long Term Evolution) access technology, but which also caters for and is backward compatible with E-UTRAN (HSDPA), UTRAN (3G) and GERAN (2G) access technologies.

In EPC (Evolved Packet Core), the concepts of a default bearer and a dedicated bearer were introduced. In EPC, the default bearer corresponds to a PDP context which is activated by a primary PDP context activation procedure in GPRS (General Packet Radio Service). A dedicated bearer corresponds to a PDP context created by a network requested second PDP context activation procedure.

QoS handling of individual service data packet flows in 3GPP defined mobile data networks (2G/3G/LTE/EPC) involves so-called dedicated bearers. For UTRAN and GERAN, dedicated bearer handling is implemented using the procedures for network requested secondary PDP context activation procedures.

For further details on dedicated bearer handling for 3GPP networks see 3GPP TS 23.203—(Policy and charging control architecture), 3GPP TS 23.060—General Packet Radio Service (GPRS); Service description; Stage 2) and 3GPP TS 23.401—General Packet Radio Service (GPRS) enhancements for Evolved Universal Terrestrial Radio Access Network (E-UTRAN) access).

FIGS. 1 and 2 show the general architecture of the SAE (system architecture evolution)/EPC (evolved packet core) network under 3GPP. FIG. 1 corresponds to—TS23.401 V.10.2.1-2011-01—FIG. 4.2.1-1 and shows a prior art non-roaming network architecture in which communication for a mobile terminal, or user entity, UE, may be carried through various 3GPP access and network technologies. There is shown a GERAN (GSM EDGE Radio Access Network, —referred to as 2G) access interface (comprising a BSS (Base Station Subsystem (not shown)), a UTRAN (UMTS Terrestrial Access Network, —referred to as 3G) interface (comprising a NodeB base station (not shown)) and an E-UTRAN (referred to as LTE (Long Term Evolution)) interface (comprising an eNodeB base station (not shown)).

On the core network side, the GERAN and the UTRAN access networks both have interfaces to a SGSN (Serving GPRS Support Node). The MME (Mobility Management Entity) is the key control node for the LTE access-network. It is responsible for idle mode UE (User Equipment) tracking and paging procedures including retransmissions. The MME is involved in the bearer activation/deactivation process and is also responsible for choosing the SGW (Serving Gateway) for a UE at the initial attach and at time of intra-LTE handover involving Core Network (CN) node relocation.

Other known nodes shown in FIG. 1 corresponding to TS23.401 V.10.2.1-2011-01—FIG. 4.2.1-1—are HSS (Home Subscriber Server), PCEF/PGW (Packet Data network (PDN) Gateway) and PCRF (Policy Charging and Rules Function), the later nodes having connection to an operator's IP services, IMS (IP Multimedia Subsystem), PSS (Packet Switch Streaming), etc.

Control plane signaling concerning the user entity is transmitted over the S1-MME interface while user plane signaling concerning the user entity is transmitted over the S1-U user plane. Moreover, there are provided known interfaces S3, S10, S11, S4, S6a, S12, S5, Gx, SGi and Rx

FIG. 2 shows a roaming model with a visiting public land mobile network (vPLMN) and a home public land mobile network (hPLMN). In contrast to FIG. 1, there is provided a Gp interface directly between the SGSN and the PGW. The SGSN moreover shows a Gr interface coupling to the HSS.

For the operator, QoS differentiation is important for being able to utilize scarce spectrum resources in an efficient and optimum manner. For certain applications of service aware QoS-control, it is important that the control is applied to a large portion of the UE's connected to a mobile network. In case of congestion, it is pertinent to be able to effectively down-prioritize IP-packets belonging to “background type services” in order to reduce the impact on services that are more sensitive from the point of view of an end user and therefore require a higher quality of service.

The procedures defined by 3GPP to support dedicated bearers in 2G, 3G and EPC/LTE based networks require specific functionality in the UE. Some of those procedures are shown in FIGS. 3-6. At present there are virtually no 2G and 3G UEs that support this functionality. For LTE, the dedicated bearer has been defined from the start of drafting the standard and it can probably be assumed that most LTE UEs will provide support for dedicated bearers. However, it is envisioned that especially for 2G, and maybe also for 3G, there will—for a foreseeable future—be a relatively large portion of UE's that are lacking support for dedicated bearers. This will significantly limit the possibility of controlling and handling “background type traffic” in congestion situations.

### SUMMARY

It is an object of the invention to set forth methods and apparatuses for handling procedures for dedicated bearers and utilize such dedicated bearers in situations where a mobile terminal does not support dedicated bearers.

There is thus provided:

A method in a serving node for carrying out steps of a primary PDP context activation procedure comprising the steps of:
receiving an activate PDP context request signal from a user entity for a PDP context;
determining whether the user entity supports network requested dedicated bearers; and if not the case;
storing information that the user entity does not support network requested dedicated bearers.

The method in the serving node further comprises
transmitting a PDP context signal to a gateway node in which an indication that the user entity and the serving node support network requested dedicated bearers is inserted, whereby the serving node is emulating that the user entity supports network requested dedicated bearers.

A method in a serving node for carrying out steps of a network requested secondary PDP context activation procedure comprising the steps of:
receiving an initiate PDP context activation request signal from a gateway node;
determining whether the user entity supports network requested dedicated bearers; and if not the case.

The method in the serving node further comprises the steps of
without engaging in signalling with the user entity, transmitting an initiate PDP context activation response signal indicating the network requested secondary PDP context activation has been accepted;
transmitting a create PDP context request signal to the gateway node.

A method in a serving node for carrying out steps of a network initiated dedicated bearer modification procedure comprising the steps of:

for a user entity not supporting network requested dedicated bearers;
receiving an update PDP context request signal from a gateway node with a requested QoS class;
transmitting a create BSS packet flow context request or a RAB assignment request signal to a radio node;

The method in the serving node moreover comprises
upon receiving a create BSS packet flow context accept or a RAB assignment response signal from the radio node—refraining from transmitting a modify PDP context request signal to the user entity;
transmitting an update PDP context response message with a negotiated QoS class to the gateway node.

A method in a radio node for carrying out steps of a network requested secondary PDP context activation procedure OR for carrying out steps of a network requested dedicated bearer modification procedure;

for a user entity not supporting network requested dedicated bearers;
the radio node when receiving a create BSS packet flow context request signal or when receiving a RAB assignment request signal.

The method involves that
if an indication that the user supports no network requested dedicated bearer is available, storing the indication;
   the radio node is
assigning a quality of service level on a radio link to the user entity so as to substantially correspond to the quality of service of the dedicated bearer;
preventing invoking signalling towards the user entity associated with the given packet flow context or preventing bearer specific signalling towards the user entity; and
transmitting a create BSS packet flow context accept to the serving node or transmitting a RAB assignment response signal to the serving node.

A method in a serving node for carrying out steps of a network initiated dedicated bearer de-activation procedure comprising the steps of:

for a user entity not supporting network requested dedicated bearers;
the serving node
receiving a delete PDP context request signal from a gateway node;
refraining from transmitting a deactivate PDP context request signal to the user entity.

Moreover, the serving node is
transmitting a delete PDP context response message to the gateway node; and is
transmitting a BSS packet flow context procedure radio access bearer release signal or transmitting a radio access bearer release signal to the radio node.

A method for a radio node for carrying out steps of a network initiated dedicated bearer de-activation procedure,

for a user entity not supporting network requested dedicated bearers;
the radio node when receiving a create BSS packet flow context procedures signal or a radio access bearer release signal; and moreover
preventing invoking signalling towards the user entity associated with the given packet flow context or suppressing bearer related signalling with the user entity.

A serving node comprising processing means and an interface unit, the serving node being adapted for participating in a primary PDP context activation procedure, the processing means being adapted for:
receiving an activate PDP context request signal from a user entity for a PDP context;
determining whether the user entity supports network requested dedicated bearers;
   and if not the case;
storing information that the user entity does not support network requested dedicated bearers.

Moreover, the serving node is
transmitting a PDP context signal to a gateway node in which an indication that the user entity and the serving node support network requested dedicated bearers is inserted, whereby the serving node is emulating that the user entity supports network requested dedicated bearers.

A serving node comprising processing means and an interface unit, the serving node being adapted for participating in a network requested secondary PDP context activation procedure, the processing means being adapted for:
receiving an initiate PDP context activation request signal from a gateway node.

The serving node is also adapted for
determining whether the user entity supports network requested dedicated bearers;
   and if not the case;
without engaging in signalling with the user entity, transmitting an initiate PDP context activation response signal indicating the network requested secondary PDP context activation has been accepted; and
transmitting a create PDP context request signal to the gateway node.

A serving node comprising processing means and an interface unit, the serving node being adapted for participating in a network initiated dedicated bearer modification procedure, the processing means being adapted for:

for a user entity not supporting network requested dedicated bearers;
receiving an update PDP context request signal from a gateway node with a requested QoS class;
transmitting a create BSS packet flow context request or a RAB assignment request signal to a radio node.

Moreover the serving node—upon receiving a create BSS packet flow context accept or a RAB assignment response signal from the radio node—refraining from transmitting a modify PDP context request signal to the user entity;
is transmitting an update PDP context response message with a negotiated QoS class to the gateway node.

A radio node (R) comprising processing means and an interface unit, the radio node being adapted for participating in a network requested secondary PDP context activation procedure OR for participating in a network requested dedicated bearer modification procedure;

for a user entity not supporting network requested dedicated bearers;
the radio node when receiving a create BSS packet flow context request signal or when receiving a RAB assignment request signal;
if an indication that the user supports no network requested dedicated bearer is available, storing the indication.

The radio node is
assigning a quality of service level on a radio link to the user entity so as to substantially correspond to the quality of service of the dedicated bearer;
preventing invoking signalling towards the user entity associated with the given packet flow context or preventing bearer specific signalling towards the user entity; and is
transmitting a create BSS packet flow context accept to the serving node or transmitting a RAB assignment response signal to the serving node.

A serving node comprising processing means and an interface unit, the serving node being adapted for participating in a network initiated dedicated bearer de-activation procedure comprising the steps of:

for a user entity not supporting network requested dedicated bearers;
receiving a delete PDP context request signal from a gateway node;
refraining from transmitting a deactivate PDP context request signal to the user entity.

The serving node is further
transmitting a delete PDP context response message to the gateway node;
transmitting a BSS packet flow context procedure radio access bearer release signal or transmitting a radio access bearer release signal to the radio node.

A radio node comprising processing means and an interface unit, the serving node being adapted for

for a user entity not supporting network requested dedicated bearers;
the radio node when receiving a create BSS packet flow context procedures signal or a radio access bearer release signal;
preventing invoking signalling towards the user entity associated with the given packet flow context or suppressing bearer related signalling with the user entity.

According to one aspect of the invention—for terminals that does not support dedicated bearer handling—a dedicated QoS enforcement per service data flow in the downlink direction is provided while a dedicated bearer handling for service data packet flow differentiation in the packet core network is provided allowing for dedicated QoS enforcement per flow.

According to a further aspect of the invention the serving node acts on behalf of the UE towards the gateway node and emulates the signaling needed. Thereby, no signaling messages related to the dedicated bearer are transmitted to the UE. As seen toward the radio node, the serving node will request handling of radio resources with a specific QoS-profile in accordance with the known procedures for dedicated bearer handling defined by 3GPP standards. According to a further aspect, an indicator informing the radio node that the UE is not aware of any corresponding dedicated bearer handling may be forwarded in order to enable any potential adaptations or optimizations needed.

Further advantages of the invention will appear from the following detailed description of the invention.

### BRIEF DESCRIPTION OF THE DRAWINGS

FIG. 1 show basic elements of the prior art SAE/EPC network architectures and interfaces, TS23.401 V.10.2.1-2011-01—FIG. 4.2.1-1, and

FIG. 2 shows a further known network architecture,

FIG. 3 shows a prior art primary PDP context activation procedure corresponding to Fig. 64 of TS23.060 V10.2.0: PDP CONTEXT ACTIVATION PROCEDURE FOR IU MODE

FIG. 4 shows a prior art network requested secondary PDP context activation procedure, corresponding to fig. 69B of TS23.060 V10.2.0: NETWORK REQUESTED SECONDARY PDP CONTEXT ACTIVATION PROCEDURE USING GN,

FIG. 5 shows a prior art network initiated dedicated bearer modification procedure corresponding to FIG. 71B OF TS23.060 V10.2.0: GGSN-INITIATED PDP CONTEXT MODIFICATION PROCEDURE, IU MODE,

FIG. 6 shows a prior art network initiated dedicated bearer deactivation procedure corresponding to FIG. 77 OF TS23.060 V10.2.0: GGSN-INITIATED PDP CONTEXT DEACTIVATION PROCEDURE,

FIG. 7 shows a primary PDP context activation procedure involving GERAN according to the invention,

FIG. 7a shows a method for a serving node for the procedures shown in 7 and 8,

FIG. 8 shows primary PDP context activation procedure involving UTRAN according to the invention,

FIG. 9 shows a network requested secondary PDP context activation procedure involving GERAN according to the invention,

FIG. 9a+b shows a method for a serving node for the procedures shown in 9 and 10,

FIG. 9c shows a method for the procedures for a radio node shown in 9 and 10,

FIG. 10 shows a network requested secondary PDP context activation procedure involving UTRAN according to the invention,

FIG. 11 shows a network initiated dedicated bearer modification procedure involving GERAN according to the invention,

FIG. 11a shows a method for a serving node for the procedures shown in 11 and 12,

FIG. 11b shows a method for a radio node for the procedures shown in 11 and 12,

FIG. 12 shows a network initiated dedicated bearer modification procedure involving UTRAN according to the invention,

FIG. 13 shows a network initiated dedicated bearer deactivation procedure according to the invention involving GERAN according to the invention,

FIG. 13a shows a method for a serving node for the procedures shown in 13 and 14,

FIG. 13b shows a method for a radio node for the procedures shown in 13 and 14,

FIG. 14 shows a network initiated dedicated bearer deactivation procedure according to the invention involving UTRAN according to the invention,

FIG. 15 shows a serving gateway apparatus and a radio node apparatus for the embodiments of the invention, and

FIG. 16 shows another representation of a radio node apparatus for the embodiments of the invention.

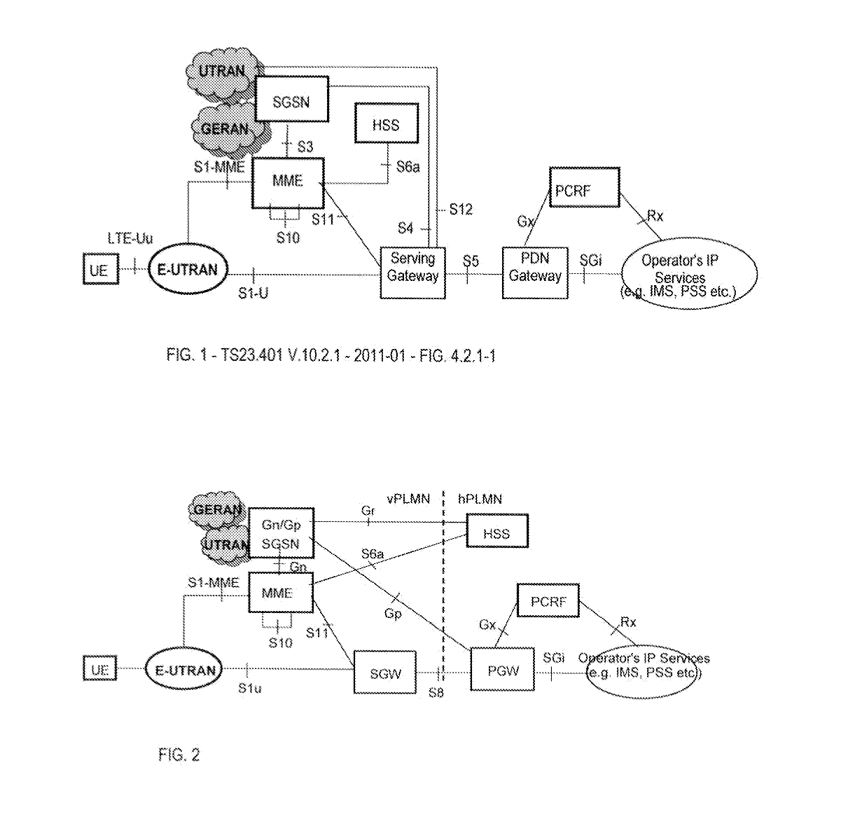

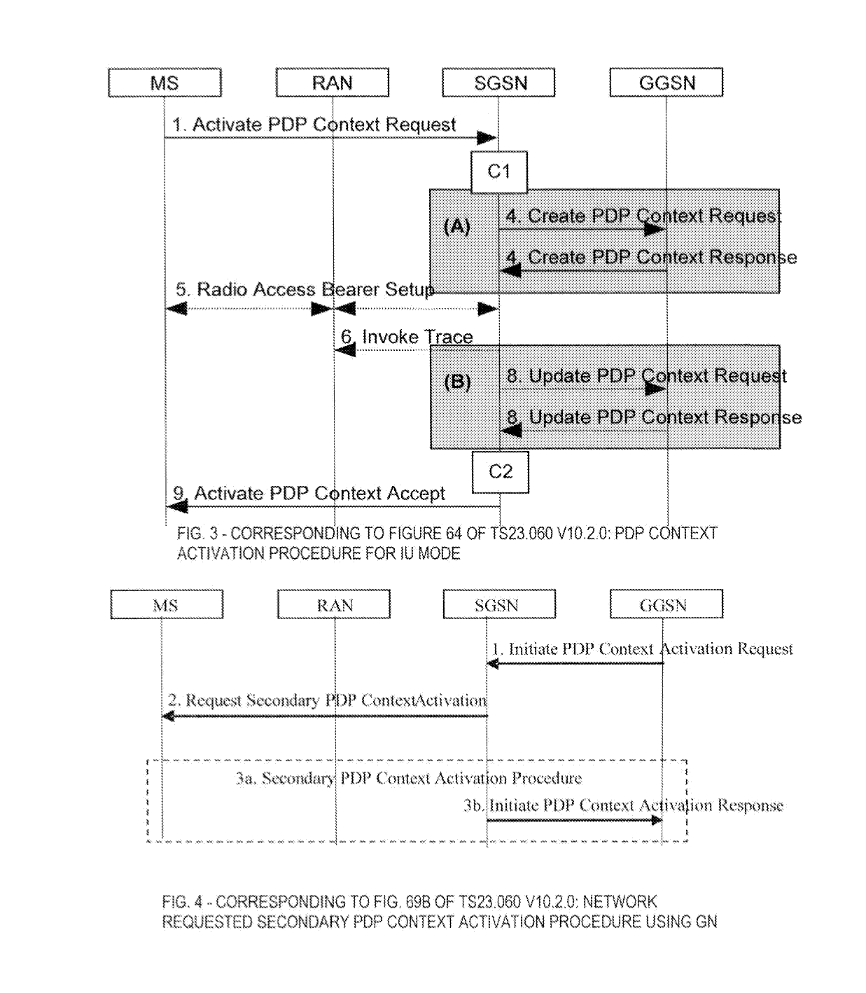

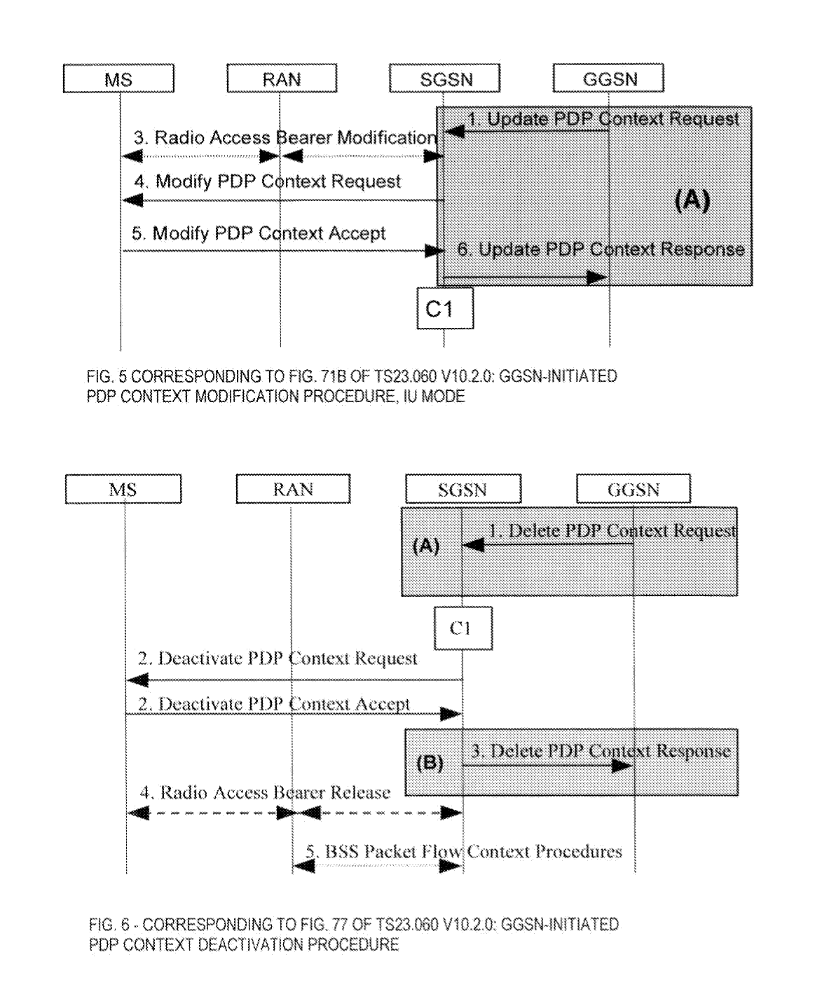

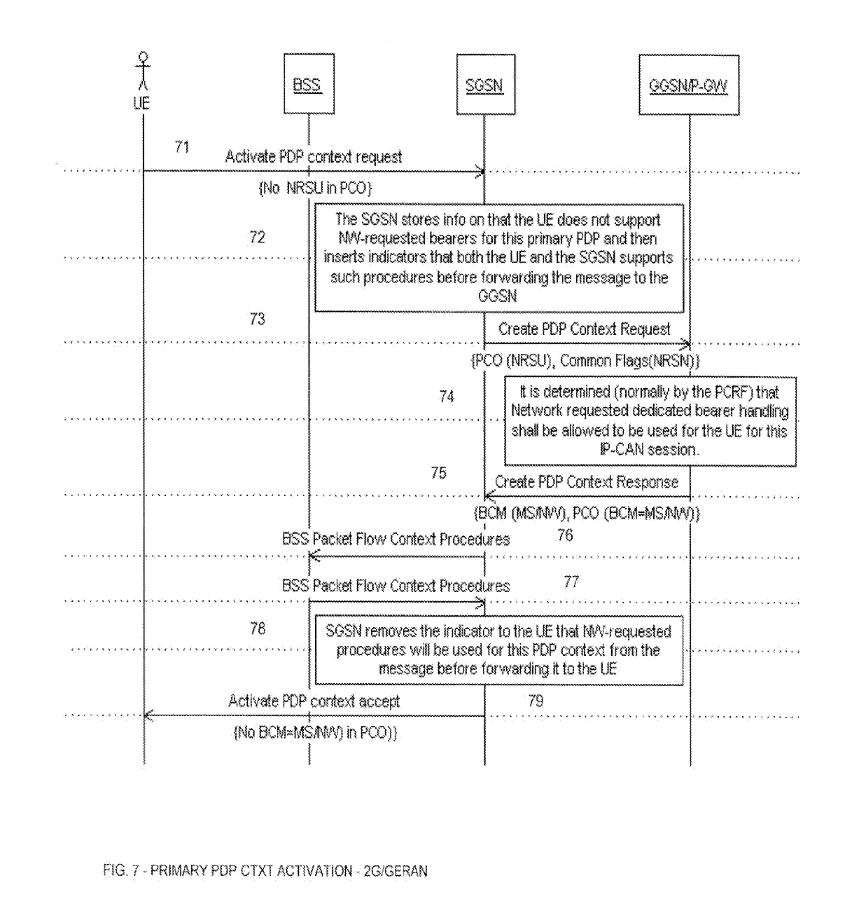

### DETAILED DESCRIPTION

The method described here is applicable for the case when the network supports handling of network requested dedicated bearer handling but the UE does not support dedicated bearers. For instance, the invention is applicable to situations in which the Bearer Control Mode (BCM) of the UE is ‘MS-Only’ and the network (NW Bearer Control Mode (BCM) BCM is ‘MS/NW’.

In the following, various embodiments of the invention will be explained involving at least a user entity UE, a radio node R, a serving node S and a gateway node G. The invention may be utilized at least both for 2G and 3G access technologies. The radio node may for instance be a 2G BSS (Base Station Set) radio node or a UTRAN radio node. The serving node may be a SGSN possibly with a Gp interface as shown in FIG. 2 and the gateway node may be GGSN or P-GW. More examples will be given later.

### Primary PDP Context Activation Procedure

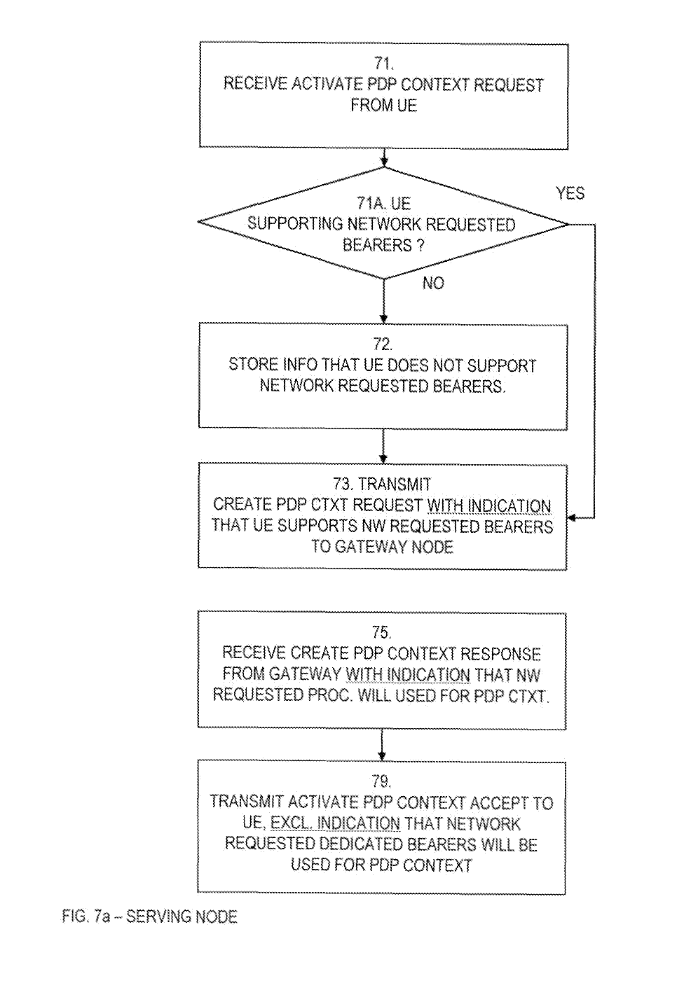

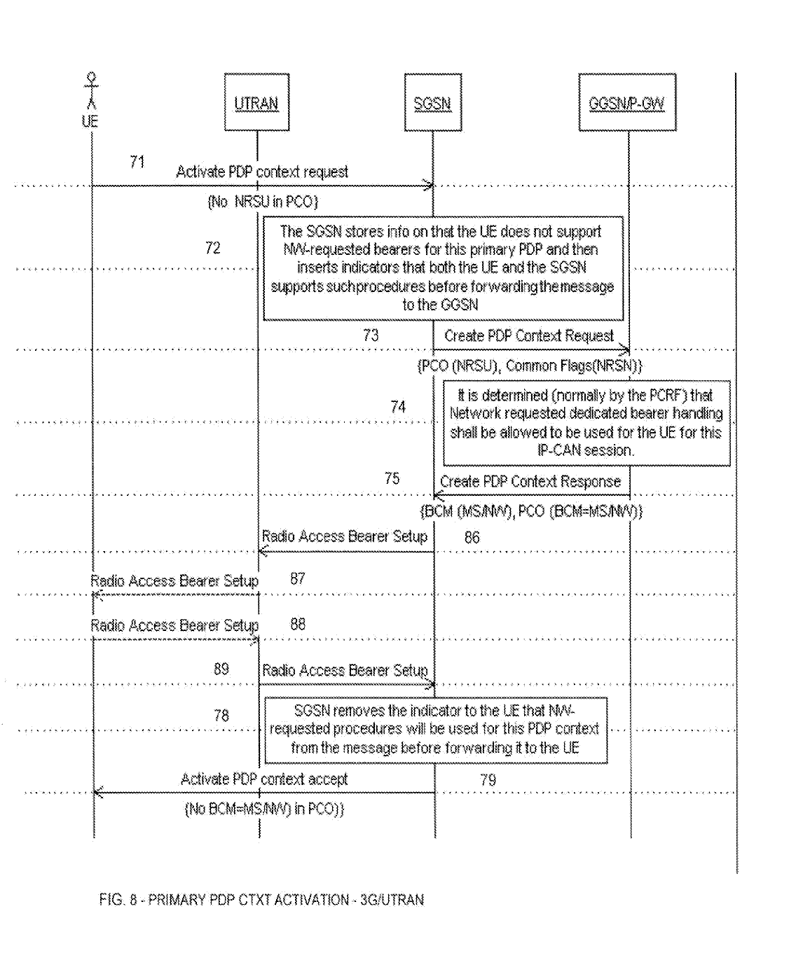

FIG. 7 shows a primary PDP context activation procedure involving GERAN according to the invention, FIG. 8 shows primary PDP context activation procedure involving UTRAN according to the invention, and FIG. 7a shows a method for a serving node for the procedures shown in 7 and 8.

As shown in FIG. 7, when a Create PDP-context request message 71 (No RSU in PCO) is received from the UE as part of the Primary PDP context procedure.

In 72, The serving node S stores information that the user entity does not support network requested bearers for this primary PDP and then inserts indicators that both the user entity and the serving node supports such procedures.

In 73 the serving node transmits a create PDP context request signal with the known indications PCO(NRSU) common flags (NRSN) to the gateway node.

In 74 the gateway node or the PRCF determines that the network requested dedicated bearer handling shall be allowed to be use for the UE for the IP-CAN session and transmits a create PDP context response signal 75 with BCM (MS/NW) and PCO MS/NW back to the serving node.

Hence, the serving node, as also illustrated in FIG. 7a, undertakes steps of a primary PDP context activation procedure comprising the steps of:
receiving 71 an activate PDP context request signal from a user entity U1 for a PDP context;
determining 71A whether the user entity supports network requested bearers; and if not the case;
storing information 72 that user entity does not support network requested bearers;
transmitting 73 a PDP context signal to a gateway node G, (GGSN) in which an indication (NRSU) that the user entity and the serving node support network requested bearers is inserted, whereby the serving node is emulating that the user entity supports network requested bearers.

If the UE supports network requested bearers in step 71A, the method goes to step 73.

Subsequently, the serving node is
receiving 75 a create PDP context response signal from the gateway node G, with a further indication (BCM=MS/NW) that network requested procedures will be used for the requested PDP context;

The serving node undertakes transmitting on or more BSS packet flow context procedure signals 76 for the GERAN case FIG. 7 or a radio access bearer setup 86 for the UTEAN case 86 to the user entity.

For the GERAN case, a BSS packet flow context procedure signal 77 is transmitted back from the radio node. Likewise, radio access bearer signals 87-88 and 89 are exchanged in the UTRAN case, c.f. FIG. 8.

The serving node 78 removes the indicator received under step 75 that network requested procedures will be used for the PDP context in question and the serving node is
transmitting 79 an activate PDP context accept signal to the user entity, excluding the further indication (no BCM=MS/NW) that network requested procedures will be used for the requested PDP context.

### Network Requested Secondary PDP Context Activation

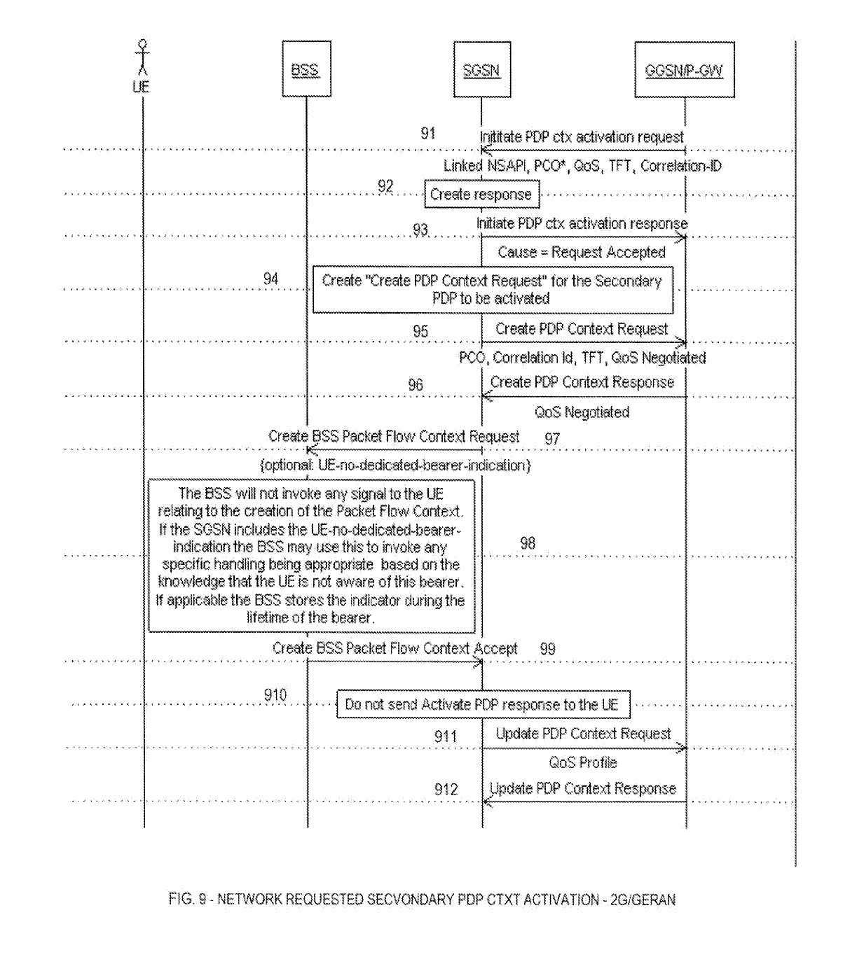

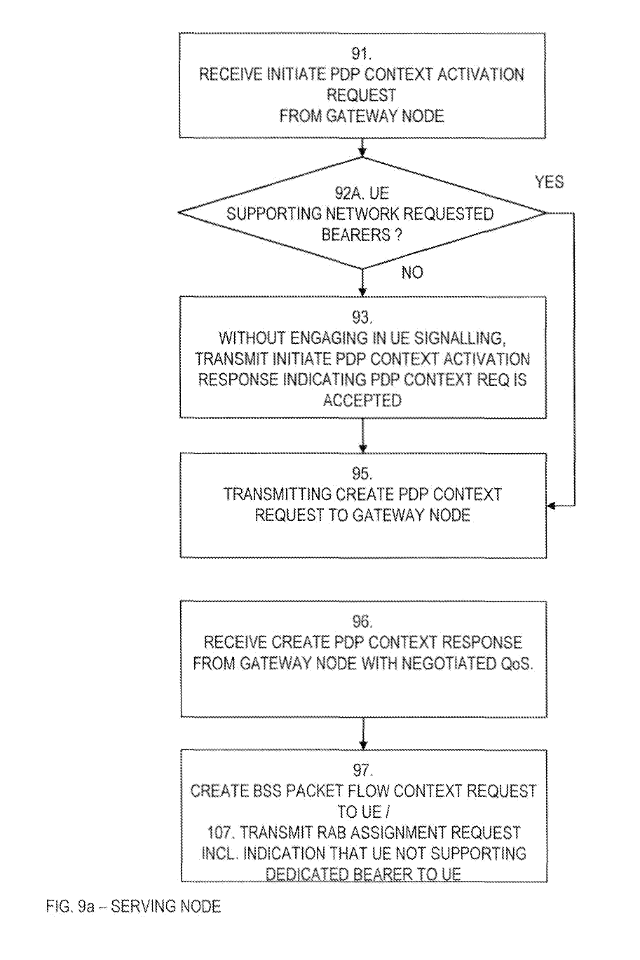

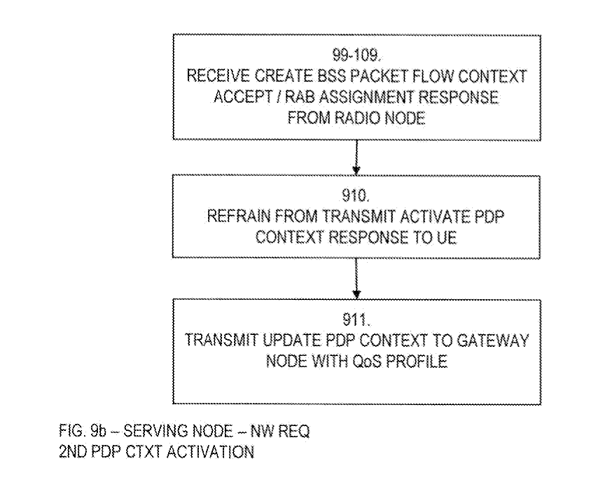

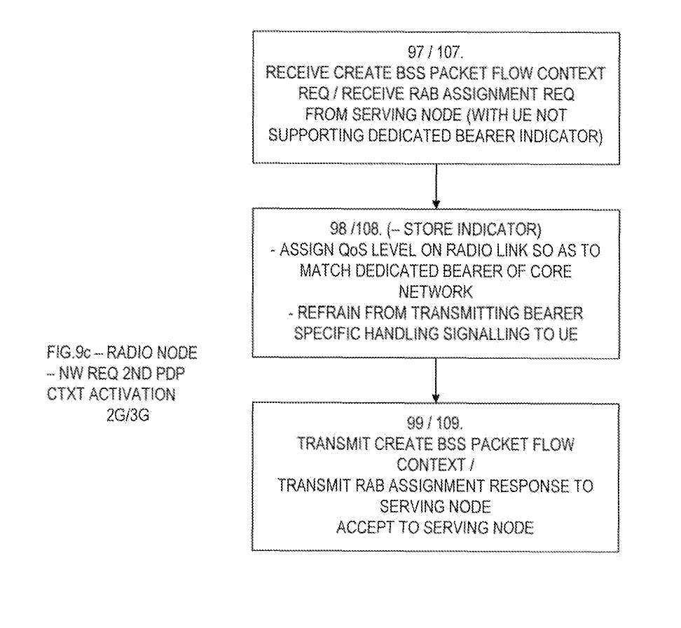

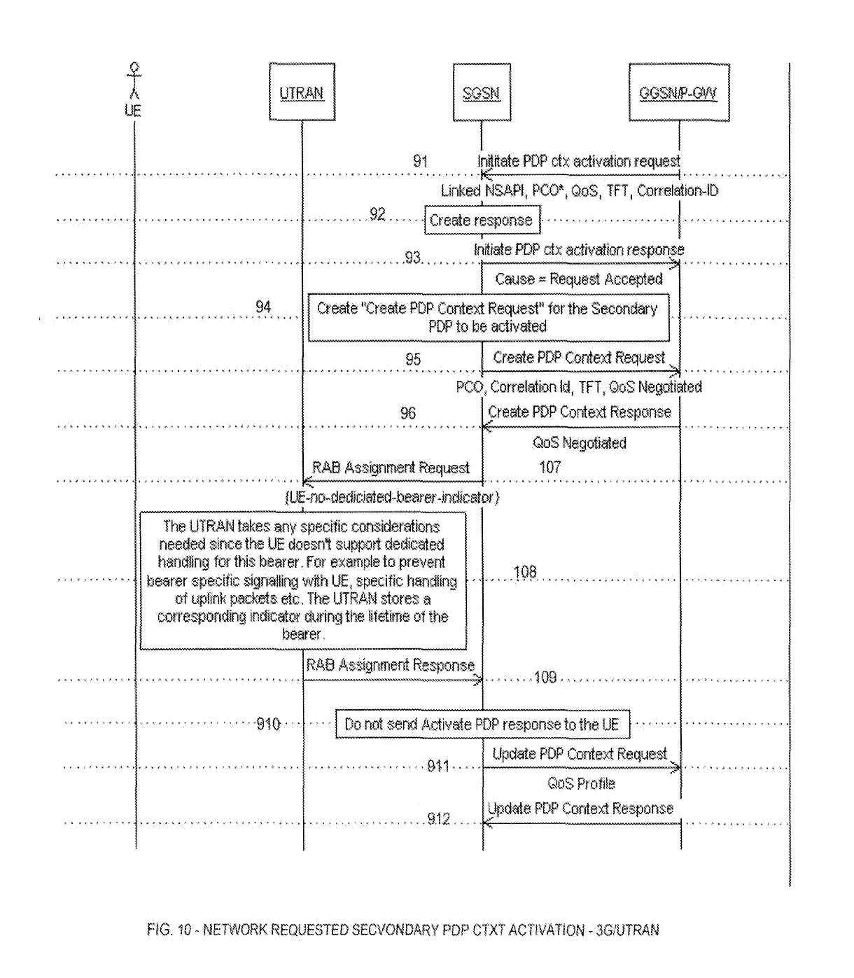

In the following, an embodiment of the invention pertaining to network requested secondary PDP context activation procedures will be explained. FIG. 9 shows a network requested secondary PDP context activation procedure involving GERAN according to the invention, while FIG. 10 shows a network requested secondary PDP context activation procedure involving UTRAN according to the invention. Reference will also be made to FIG. 9a+b showing a method for a serving node for the procedures shown in 9 and 10, and FIG. 9c showing a method for the procedures for a radio node shown in 9 and 10. As appears in the following some steps are common for the procedures.

In FIG. 9, a network requested secondary PDP context activation procedure according to the invention, is disclosed.

When, in order to request the setup of a NW-requested secondary PDP context, an Initiate PDP context activation request signal 91 is received from the gateway node (GGSN), the serving node (SGSN) will not forward this request to the UE but instead immediately respond by sending a successful “Initiate PDP context activation response” signal 93 back to the GGSN.

The serving node (SGSN) will then initiate a Secondary PDP context activation procedure towards the gateway node (GGSN) based on the information included in the received request 91 (down-link and up-link TFT, QoS etc) and create a “Create PDP context request” 95 for a secondary PDP (including serving node (SGSN) side TEIDs etc.) and send it to the serving node, e.g. the GGSN. The serving node (SGSN) stores the information that for this PDP-context, no signals shall be forwarded to the user entity, UE.

When the gateway node (GGSN) responds with a “Create PDP Context Response 96 (including GGSN-side TEIDs and the Negotiated QoS-profile etc), the serving node (SGSN) will, in case of a UTRAN, request the setup—RAB assignment request signal 107—of a corresponding radio-resource (UTRAN:RAB, GERAN:PFC) from the radio-system (BSS/RAN). An indicator that the UE is not aware of any corresponding dedicated bearer handling may be provided in the RAB assignment request 107. This information may e.g. be used to if needed adapt the downlink forwarding mechanisms correspondingly or be used for a corresponding adaptation of the forwarding of uplink packets on the default bearer.

When the radio-system acknowledges the setup of the requested radio-resource the serving node (SGSN) it confirms this to the gateway node (GGSN) by sending an Update PDP Context Request 911 in according with the 3GPP standard, but it does not forward any Activate PDP Context Response 910 to the UE.

Hence, seen from the serving node and as illustrated in FIG. 9a, the following steps are undertaken:
receiving 91 an initiate PDP context activation request signal from a gateway node G.

The signal may comprise the known “linked NSAPI”, “PCO*”, “QoS”, “TFT” and “correlation ID”,
determining 92A whether the user entity supports network requested bearers; and if not the case;
without engaging in signalling with the user entity, transmitting 93 an initiate PDP context activation response signal indicating the network requested secondary PDP context activation has been accepted, hence the field “cause” is set to “request accepted”; Subsequently, the serving node creates 94 a “create PDP context request” for the secondary PDP context to be activated, and—transmits 95 a create PDP context request signal to the gateway node, with fields “PCO”, “Correlation ID”, “TFT”, “QoS negotiated”.

If the UE supports network requested bearers in step 92A, the method goes to step 95.

The method comprises the further steps of the serving node, if interacting with a GERAN radio node;
receiving 96 a create PDP context response signal from the gateway node G, with a negotiated quality of service;
transmitting 97 a create BSS packet flow context request signal to the user entity, optionally comprising an indication “UE no dedicated bearer indictor”, that the user entity supports no dedicated bearer.

Alternatively, if interacting with a UTRAN radio node, the serving node is
receiving 96 a create PDP context response signal from the gateway node G, with a negotiated quality of service;
transmitting 107 a transmit RAB assignment request signal to the user entity, comprising an indication (UE no dedicated bearer indictor, that the user entity supports no dedicated bearer.

Finally, after completion of any of the alternatives above and as illustrated in FIG. 9b, the serving node upon receiving 109 a RAB assignment response signal or a create BSS packet flow context accept signal 99 is
refraining 910 from transmitting a PDP context response signal to the user entity;
transmitting 911 an update PDP context request signal to the gateway node.

The serving node will subsequently receive 912 an update PDP context response signal, from the gateway node.

Seen from the radio node, the following steps are undertaken, as shown in FIG. 9c:
the radio node when receiving a create BSS packet flow context request signal 97 or when receiving a RAB assignment request signal 107
if the indication is available, storing 98, 108 the indication that the user supports no dedicated bearer during the lifetime of the bearer or until modified;
assign 98, 108 a quality of service level on a radio link to the user entity U1 so as to substantially correspond to the quality of service of the dedicated bearer;
preventing 98, 108 invoking signalling towards the user entity associated with the given packet flow context 98 or preventing bearer specific signalling 108 towards the user entity.

In other words, The GERAN/BSS radio node in step 98 will not invoke any signal to the user entity relating to the creation of the packet flow context. If the serving node, SGSN, includes the “UE-no-dedicated-bearer” indication, the BSS may use this indication to invoke any specific handling being appropriate based on the knowledge that the user entity is not aware of this bearer. The UTRAN stores the corresponding indicator during the lifetime or until modified.

In other words, concerning step 108, the UTRAN radio node 108 takes any specific considerations needed since the user entity does not support dedicated handling for bearer in question. For example, bearer specific handling of up-link packets may be prevented. The UTRAN stores the corresponding indicator during the lifetime of the bearer or until modified.

Subsequently, the radio node will be transmitting 99 a create BSS packet flow context accept to the serving node or transmitting a RAB assignment response 109 signal to the serving node.

If an Inter-serving node SGSN change occurs during the lifetime of the primary PDP-context/IP-CAN session, it is provided that the “old” SGSN to inform (not shown) the “new” SGSN that NW-requested dedicated bearer procedures are not supported by the UE for the given session and that the “new” SGSN shall act on its behalf if/when any such procedures are applied by or requested from the network side.

### Network Initiated Dedicated Bearer Modification Procedure

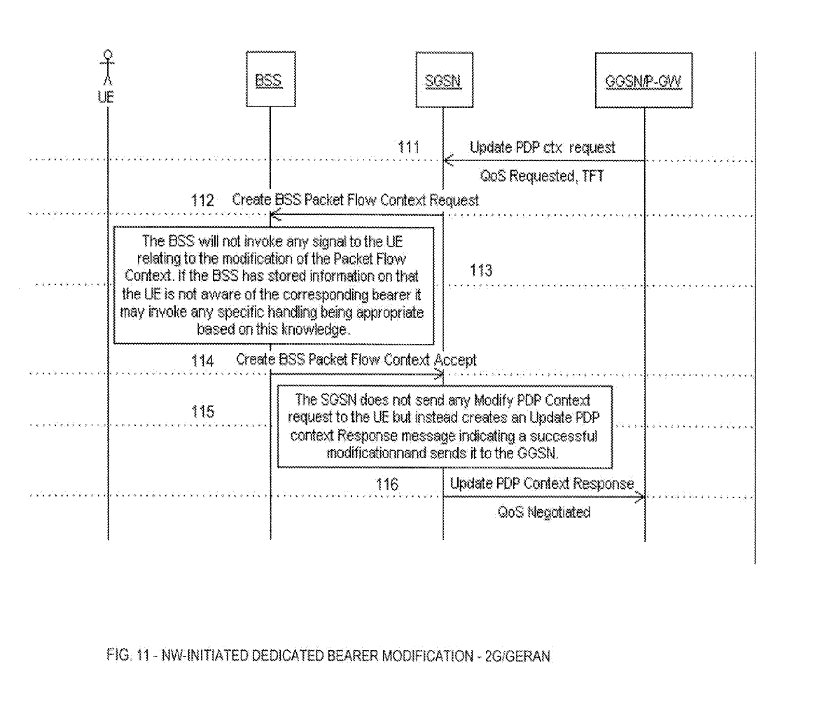

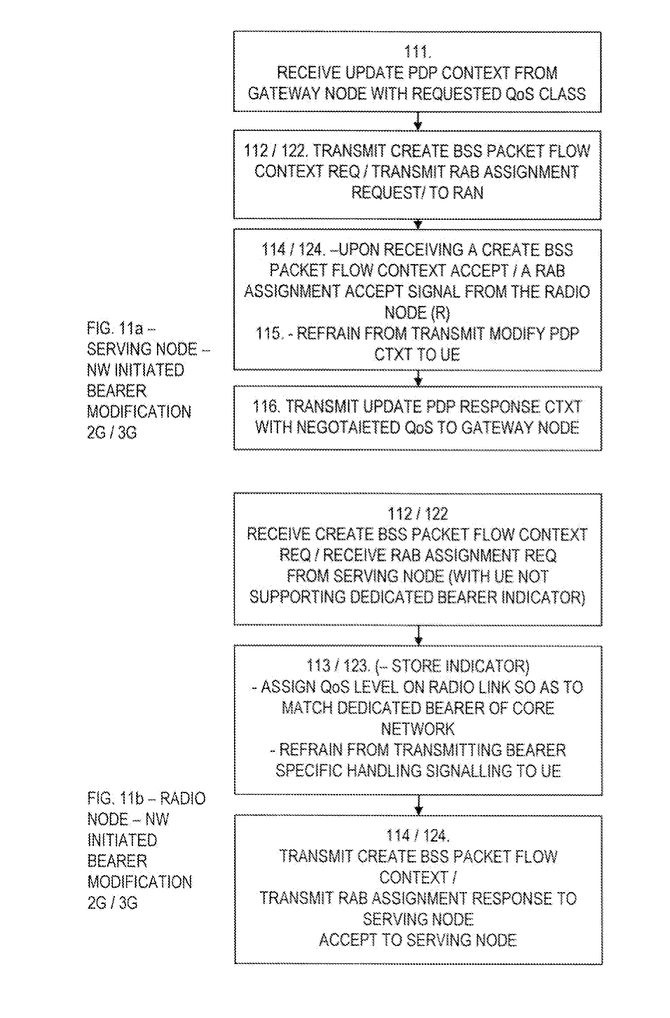

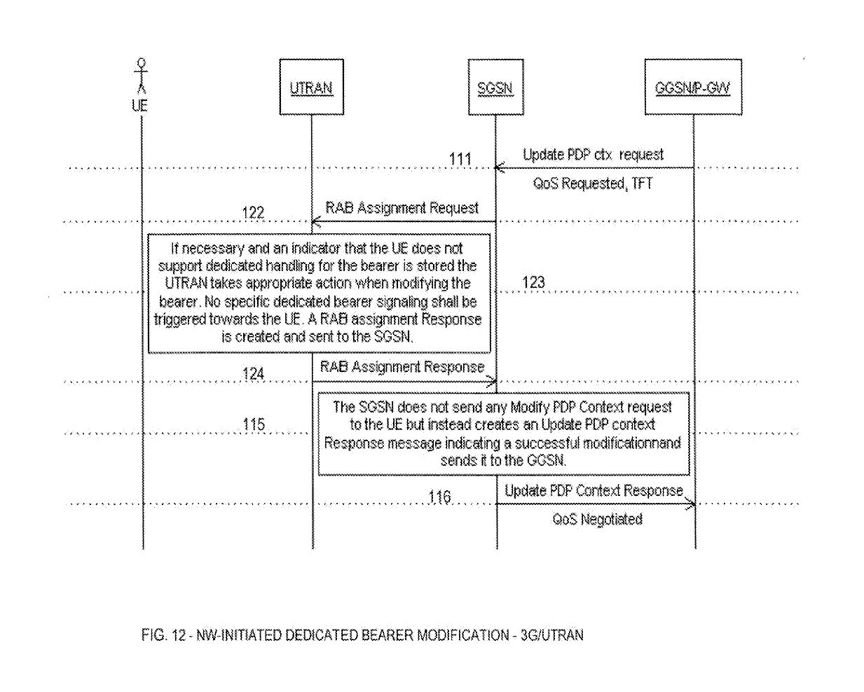

FIG. 11 shows a network initiated dedicated bearer modification procedure involving GERAN according to the invention. FIG. 12 shows a network initiated dedicated bearer modification procedure involving UTRAN according to the invention. FIG. 11a shows a method for a serving node for the procedures shown in 11 and 12 and FIG. 11b shows a method for a radio node for the procedures shown in 11 and 12.

If the serving node (SGSN) receives a gateway node (GGSN) initiated or PDN-GW initiated Update PDP context request 111 indicating a modification of the dedicated bearer, any changes to the radio-resources needed shall be negotiated with the radio-system. Based on the outcome of this, a corresponding Update PDP context response signal 116 is created and is transmitted back to the initiating gateway node. No Modify PDP Context Request 15 shall be forwarded to the UE.

There is provided as further shown in FIG. 11a, a method in a serving node S for carrying out a network initiated dedicated bearer modification comprising the steps of:
receiving 111 an update PDP context request signal from a gateway node G with a requested QoS class and a “TFT” field;
transmitting 112 a create BSS packet flow context request or 122 a RAB assignment request signal to a radio node R;
upon receiving a create BSS packet flow context accept 114 or a RAB assignment response signal 124 from the radio node R—refraining 115 from transmitting a modify PDP context request signal to the user entity; More specifically as, illustrated in FIGS. 11 and 12, in step 115, the serving node does not send any Modify PDP context request to the use entity but instead creates an update PDP context response message indicating a successful modification and sends it to the gateway node;
transmitting 116 an update PDP context response message with a negotiated QoS class to the gateway node.

As shown in FIG. 11b, having many similarities with FIG. 9c, there is provided a method for a radio node R for carrying out steps of a network requested dedicated bearer modification procedure; for a user entity not supporting network requested dedicated bearers; the radio node when receiving a create BSS packet flow context request signal 112 n the GERAN case or when receiving a RAB assignment request signal 122 in the UTRAN case
if an indication that the user supports no network requested dedicated bearer is available, storing 113, 123 the indication during the lifetime of the bearer;
assigning 113, 123 a quality of service level on a radio link to the user entity U1 so as to substantially correspond to the quality of service of the dedicated bearer;
preventing 113, 123 invoking signalling towards the user entity associated with the given packet flow context 98, 113 or preventing bearer specific signalling 108, 123 towards the user entity;
transmitting 114 a create BSS packet flow context accept to the serving node in the GERAN case or transmitting a RAB assignment response 124 signal to the serving node in the UTRAN case.

More specifically as illustrated in FIG. 11, for the GERAN case, step 113, the BSS will not invoke any signalling to the user entity relating to the modification of the packet flow context. If the BSS has stored information on that the user entity is not aware of the corresponding bearer it may invoke any specific handling being appropriate based on this knowledge. For, the UTRAN case, as illustrated in FIG. 12, in step 123, if necessary and an indicator that the user entity does not support dedicated handling for the bearer is stored, the UTRAN takes appropriate action when modifying the bearer. No specific dedicated bearer signalling shall be triggered towards the user entity. A RB assignment response signal is created and sent to the gateway node, e.g. the SGSN.

### Network Initiated Dedicated Bearer Deactivation Procedure

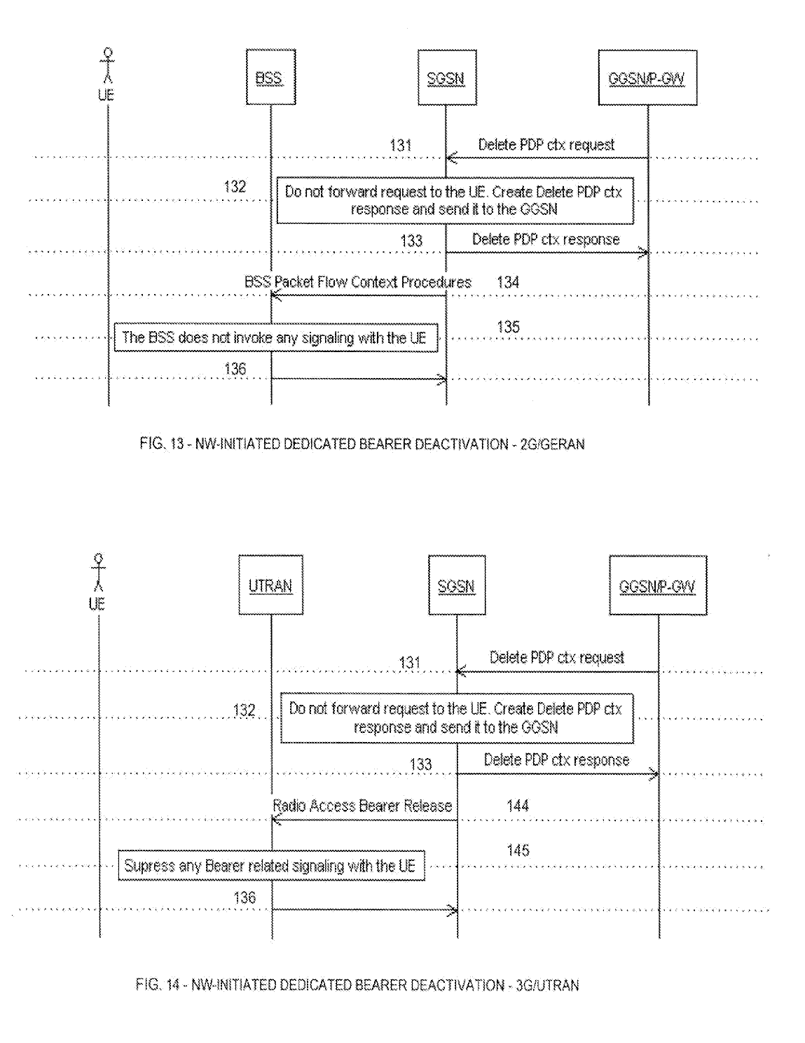

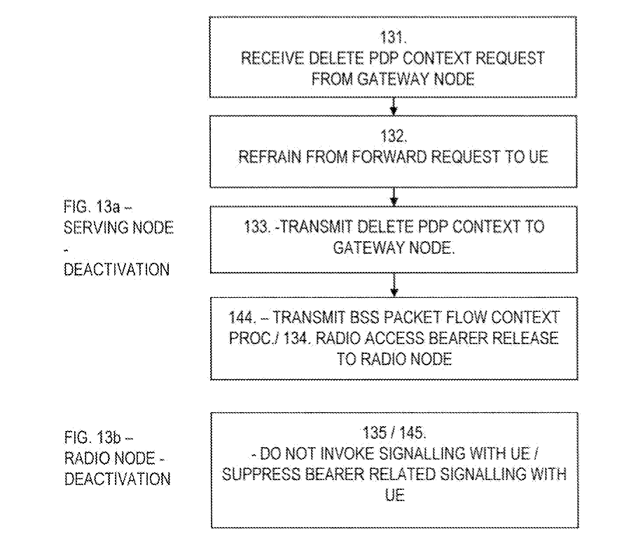

FIG. 13 shows a network initiated dedicated bearer deactivation procedure according to the invention involving GERAN according to the invention, while FIG. 14 shows a network initiated dedicated bearer deactivation procedure according to the invention involving UTRAN according to the invention. FIG. 13a shows a method for a serving node for the procedures shown in 13 and 14, while FIG. 13b shows a method for a radio node for the procedures shown in 13 and 14.

When a Delete PDP context request 131 referring to the dedicated bearer is received from the gateway node (GGSN) the serving node (SGSN) shall—if the corresponding radio resources are active—request a release of those from the radio-system. A delete PDP context response 133 shall, in accordance with the standard, be returned to the GGSN. The Delete PDP context request message 132 shall not be forwarded to the UE by the serving node.

There is provided a method in a serving node S, as further illustrated in FIG. 13a, for carrying out a network initiated dedicated bearer de-activation comprising the steps of:
receiving 131 a delete PDP context request signal from a gateway node G;
refraining 132 from transmitting a deactivate PDP context request signal to the user entity;
transmitting 133 a delete PDP context response message to the gateway node;
transmitting 134 a BSS packet flow context procedure radio access bearer release signal or transmitting 144 a radio access bearer release signal to the radio node R.

Moreover there is provided a method for a radio node R, as further illustrated in FIG. 13b, for carrying out a network initiated dedicated bearer de-activation,
for a user entity not supporting dedicated bearers;
the radio node when receiving a create BSS packet flow context procedures signal 134 or a radio access bearer release signal 144;
preventing 135 invoking signalling towards the user entity U1 associated with the given packet flow context or suppressing 145 bearer related signalling with the user entity U1.

### Further Exemplary Embodiments

As mentioned above, the invention is applicable to a plurality of technologies. Below, exemplary alternative implementations are indicated.

| access | | radio | serving node | gateway |
|---|---|---|---|---|
| technology | user entity (U) | node (R) | (S) | node (G) |
| (i) 2G | MT + TE | GERAN | SGSN | GGSN |
| (ii) 3G | UE | UTRAN | SGSN | GGSN |
| (iii) 2G | MT + TE | GERAN | SGSN(S4)/SGW | PGW |
| (iv) 3G | UE | UTRAN | SGSN(S4)/SGW | PGW |
| (v) 2G | MT + TE | GERAN | SGSN | PGW |
| (vi) 3G | UE | UTRAN | SGSN | PGW |

Options i/v and i/vi are shown in figures. The person skilled in the art, is capable of utilizing features as described in other applications, for instance in implementations iii and iv, by using equivalent means where necessary, without the use of inventive skill.

In summary, concerning the methods according to the invention there is provided:

A method in a serving node S for carrying out steps of a primary PDP context activation procedure comprising the steps of:
receiving 71 an activate PDP context request signal from a user entity U1 for a PDP context;
determining 71A whether the user entity supports network requested dedicated bearers; and if not the case;
storing information 72 that the user entity does not support network requested dedicated bearers.

The method in the serving node S further comprises
transmitting 73 a PDP context signal to a gateway node G, GGSN in which an indication NRSU that the user entity and the serving node support network requested dedicated bearers is inserted, whereby the serving node is emulating that the user entity supports network requested dedicated bearers.

The Method may further comprise the steps of,
receiving 75 a create PDP context response signal from the gateway node G, with a further indication that network requested procedures will be used for the requested PDP context;
transmitting 79 an activate PDP context accept signal to the user entity, excluding the further indication that network requested dedicated bearers will be used for the requested PDP context.

There is further provided, a method in a serving node S for carrying out steps of a network requested secondary PDP context activation procedure comprising the steps of:
receiving 91 an initiate PDP context activation request signal from a gateway node G;
determining 92A whether the user entity supports network requested dedicated bearers; and if not the case.

The method in the serving node S may further comprise the steps of
without engaging in signalling with the user entity, transmitting 93 an initiate PDP context activation response signal indicating the network requested secondary PDP context activation has been accepted;
transmitting 95 a create PDP context request signal to the gateway node.

The method may further comprise the steps of:

if interacting with a GERAN radio node;
receiving 96 a create PDP context response signal from the gateway node G, with a negotiated quality of service;
transmitting 97 a create BSS packet flow context request signal to the user entity, optionally comprising an indication, that the user entity supports no network requested dedicated bearer.

Alternatively, if interacting with a UTRAN radio node; the method in a serving node S for carrying out steps of a network requested secondary PDP context activation procedure may further comprise
receiving 96 a create PDP context response signal from the gateway node G, with a negotiated quality of service;
transmitting 107 a transmit RAB assignment request signal to the user entity, comprising an indication, that the user entity supports no network requested dedicated bearer.

Finally, the above method in a serving node S for carrying out steps of a network requested secondary PDP context activation procedure may further comprise
upon receiving 109 a RAB assignment response signal or a create BSS packet flow context accept signal 99;
refraining 910 from transmitting a PDP context response signal to the user entity;
transmitting 911 an update PDP context request signal to the gateway node.

There is further provided, a method in a serving node S for carrying out steps of a network initiated dedicated bearer modification procedure comprising the steps of:

for a user entity not supporting network requested dedicated bearers;
receiving 111 an update PDP context request signal from a gateway node G with a requested QoS class;
transmitting 112 a create BSS packet flow context request or 122 a RAB assignment request signal to a radio node R;

The method in the serving node S moreover comprises
upon receiving a create BSS packet flow context accept 114 or a RAB assignment response signal 124 from the radio node R—refraining 115 from transmitting a modify PDP context request signal to the user entity;
transmitting 116 an update PDP context response message with a negotiated QoS class to the gateway node.

There is further provided, a method in a radio node R for carrying out steps of a network requested secondary PDP context activation procedure OR for carrying out steps of a network requested dedicated bearer modification procedure;

for a user entity not supporting network requested dedicated bearers;
the radio node when receiving a create BSS packet flow context request signal 97; 122 or when receiving a RAB assignment request signal 107; 122.

The method involves that
if an indication that the user supports no network requested dedicated bearer is available, storing 98, 108, 113, 123 the indication;
   the radio node is
assigning 98, 108, 113, 123 a quality of service level on a radio link to the user entity U1 so as to substantially correspond to the quality of service of the dedicated bearer;
preventing 98, 108, 113, 123 invoking signalling towards the user entity associated with the given packet flow context 98, 113 or preventing bearer specific signalling 108, 123 towards the user entity; and
transmitting 99; 114 a create BSS packet flow context accept to the serving node or transmitting a RAB assignment response 109; 124 signal to the serving node.

Further, the above method may, if the RAB assignment request 107 comprises an indication that the user entity supports no network requested dedicated bearer, comprise the step of
the radio node R, storing 108 the indication that the user supports no network requested dedicated bearer.

The step of assigning 98, 108, 113, 123 a quality of service level on a radio link to the user entity corresponding to the network requested dedicated bearer, may further involve that

the respective quality of service level QoS_A for a first downlink stream DL3 corresponds to the quality of service QoS_A of a default bearer DFT_A′ and the respective quality of service level QoS_B for a second downlink stream DL4 corresponds to the quality of service QoS_B of the network requested dedicated bearer DCT_B′.

There is further provided, a method in a serving node S for carrying out steps of a network initiated dedicated bearer de-activation procedure comprising the steps of:

for a user entity not supporting network requested dedicated bearers;
the serving node
receiving 131 a delete PDP context request signal from a gateway node G;
refraining 132 from transmitting a deactivate PDP context request signal to the user entity.

Moreover, the serving node is
transmitting 133 a delete PDP context response message to the gateway node; and is
transmitting 134 a BSS packet flow context procedure radio access bearer release signal or transmitting 144 a radio access bearer release signal to the radio node R.

There is further provided, a method for a radio node R for carrying out steps of a network initiated dedicated bearer de-activation procedure,

for a user entity not supporting network requested dedicated bearers;
the radio node when receiving a create BSS packet flow context procedures signal 134 or a radio access bearer release signal 144; and moreover
preventing 135 invoking signalling towards the user entity U1 associated with the given packet flow context or suppressing 145 bearer related signalling with the user entity U1.

### Apparatuses

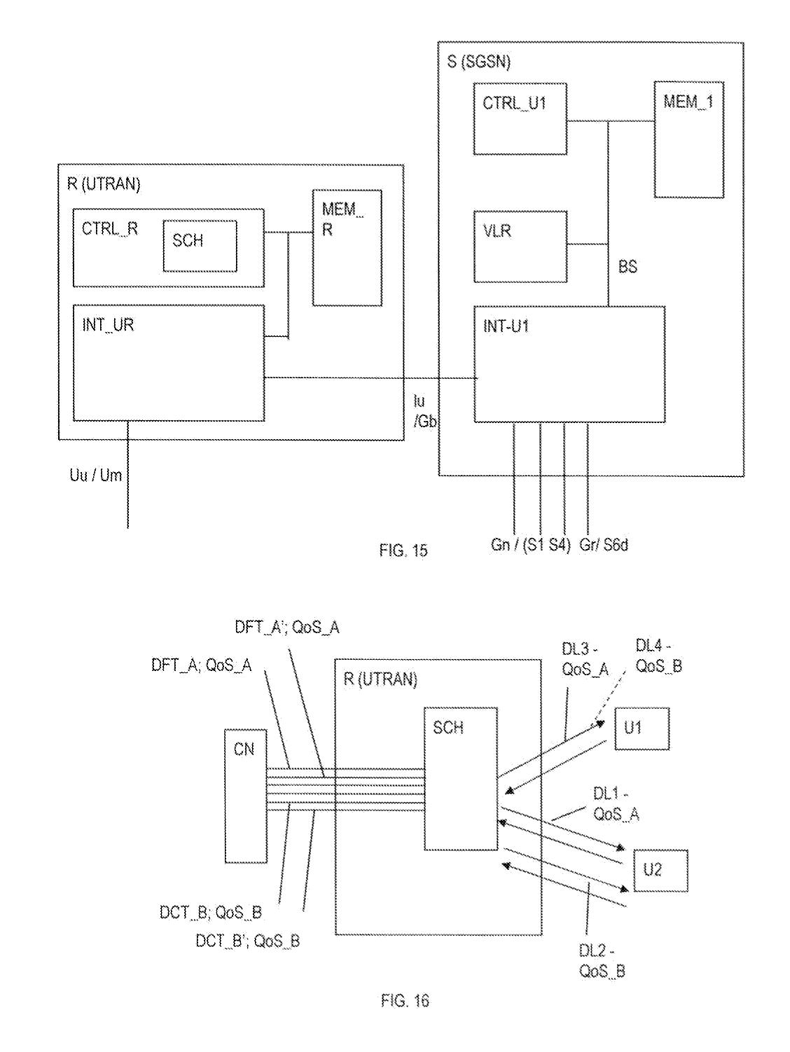

In FIG. 15 an exemplary SGSN serving node according to the invention is shown, comprising a control unit; CTRL_U1, a memory, MEM_1, a visitor's location register, VLR and an interface unit. INT_U1, providing the known interfaces Gn, S1, S4, Gr/S6d and Iu/Gb. The memory is adapted to hold instructions for carrying out the method steps defined above for the serving node by means of the control unit. The control unit may be constituted by one or more microprocessors and the memory MEM_1 may be constituted by a random access memory. An internal bus BS is also provided. The control unit and memory constitute processing means which is adapted to carry out the method shown according to FIGS. 7a, 9a, 9b, 11a and 13a. The processing means could alternatively be implemented by a FPGA (Field Programmable Gate Array) (Not shown). The processing means is adapted to transmit and receive signals on a logical level, while the interface unit transfers signals complying with physical requirements.

There is also shown a UTRAN radio access node R according to the invention comprising a control unit; CTRL_R, a memory, MEM_R, and an interface unit, INT_1, providing interfaces to the user entity over the known LTE-Uu/Um interface and to the serving node over a Iu/Gb interface. The memory MEM_R is adapted to hold instructions for carrying out the method steps defined above for radio access node by means of the control unit. The control unit may be constituted by one or more microprocessors and the memory may be constituted by a random access memory. The control unit and memory constitute processing means which is adapted to carry out the method shown according to FIGS. 9c, 11b and 13b. The processing means could alternatively be implemented by a FPGA (Field Programmable Gate Array) (Not shown). The processing means is adapted to transmit and receive signals on a logical level, while the interface unit transfers signals complying with physical requirements.

A illustrated in FIG. 16, in the downlink direction, packets to be handled in accordance with those specific QoS-requirements are detected by the gateway node (GGSN) and forwarded via the corresponding dedicated bearer, either via the serving node (SGSN) or in case of a 3G-Direct-Tunnel, directly to the radio-system (BSS or radio access node (RAN)), which transfers them to the UE in accordance with the QoS-parameters determined for the used radio-bearer. A number of bearers are provided between the serving node (the serving node and the gateway node also being denoted the core network CN are shown as established between the core network, CN, and the radio node R (e.g. UTRAN) for connecting further on to a plurality of user entities, U1 . . . U2.

By way of example, a first user entity U2 represents a user entity which is capable of handling dedicated bearers. As shown in FIG. 11, there is at least established a first downlink packet stream DL1 which transfers packets from the default bearer DFT_A. The quality of service level of the dedicated bearer is set so that the quality of service of the first packet downlink stream corresponds to one another, QoS_A. There is moreover provided a dedicated bearer; DCT_B from which a second downlink packet stream DL2 is set up having a corresponding quality of service, QoS_B.

By way of example, a second user entity U1 represents a user entity which is not capable of handling dedicated bearers. According to the invention and as shown in FIG. 11, there is at least established a third downlink packet stream DL3 which transfers packets from a default bearer DFT_A′ and a fourth packet stream DL4 which transfers packets from a dedicated bearer DCT_B′. The scheduler SCH in the radio node R handles the quality of service of the packet downlink streams so as to correspond to their assigned quality of service levels of the respective bearers. Hence, the respective quality of service level QoS_A for the third downlink stream DL 3 corresponds to the quality of service level QoS_A of default bearer DFT_A′ and the respective quality of service level of QoS_B for the fourth downlink stream DL4 corresponds to the quality of QoS_B of dedicated bearer DCT_B′.

Hence—in other words—the step of assigning a quality of service level in steps 98, 108. 113 and 123 in the radio link to the user entity corresponding to the network requested dedicated bearer, involves that the respective quality of service level QoS_A for a first downlink stream DL3 corresponds to the quality of service QoS_A of a default bearer DFT_A′ and the respective quality of service level QoS_B for a second downlink stream DL4 corresponds to the quality of service QoS_B of the network requested dedicated bearer DCT_B′. The assigned QoS level for each packet stream is stored in the memory MEM_R of the radio node.

In the uplink, the UE will forward all packets on the default bearer (primary PDP) in accordance with the QoS-related characteristics assigned to it, c.f. QoS_B in FIG. 16, hence the up-link quality of service. QoS_B, is fixed, and there is only QoS differentiation on the downlink. In another embodiment, the uplink QoS is simply assigned corresponding to that of the downlink.

A QoS enforcement in the downlink direction will depend on the application and trans-port protocol used in many cases have an impact also in the uplink direction. One example is a TCP-stream where a delay for acknowledgements in one direction may reduce the rate at which user-data packets are sent in the other direction.

To summarize, according to the invention there is provided:

Moreover there is provided a serving node S comprising processing means CTRL_U1; MEM_1 and an interface unit INT_U1, the serving node being adapted for participating in a primary PDP context activation procedure, the processing means being adapted for:
receiving 71 an activate PDP context request signal from a user entity U1 for a PDP context;
determining 71A whether the user entity supports network requested dedicated bearers; and if not the case;
storing information 72 that the user entity does not support network requested dedicated bearers.

Moreover, the serving node is
transmitting 73 a PDP context signal to a gateway node G, GGSN in which an indication NRSU that the user entity and the serving node support network requested dedicated bearers is inserted, whereby the serving node is emulating that the user entity supports network requested dedicated bearers.

The serving node may further be adapted to,
receiving 75 a create PDP context response signal from the gateway node G, with a further indication that network requested procedures will be used for the requested PDP context;
transmitting 79 an activate PDP context accept signal to the user entity, excluding the further indication that network requested dedicated bearers will be used for the requested PDP context.

Moreover there is provided a serving node S comprising processing means CTRL_U1; MEM_1 and an interface unit INT_U1, the serving node being adapted for participating in a network requested secondary PDP context activation procedure, the processing means being adapted for:
receiving 91 an initiate PDP context activation request signal from a gateway node G.

The serving node is also adapted for
determining 92A whether the user entity supports network requested dedicated bearers; and if not the case;
without engaging in signalling with the user entity, transmitting 93 an initiate PDP context activation response signal indicating the network requested secondary PDP context activation has been accepted; and
transmitting 95 a create PDP context request signal to the gateway node.

The serving node may be adapted to further:

if interacting with a GERAN radio node;
receiving 96 a create PDP context response signal from the gateway node G, with a negotiated quality of service;
transmitting 97 a create BSS packet flow context request signal to the user entity, optionally comprising an indication, that the user entity supports no network requested dedicated bearer.

Alternatively, the serving node if interacting with a UTRAN radio node;

may be further adapted to
receiving 96 a create PDP context response signal from the gateway node G, with a negotiated quality of service;
transmitting 107 a transmit RAB assignment request signal to the user entity, comprising an indication, that the user entity supports no network requested dedicated bearer.

Finally, for any of the above two alternatives, the serving node may be adapted to
upon receiving 109 a RAB assignment response signal or a create BSS packet flow context accept signal 99;
refraining 910 from transmitting a PDP context response signal to the user entity;
transmitting 911 an update PDP context request signal to the gateway node.

Moreover there is provided a serving node S comprising processing means CTRL_U1; MEM_1 and an interface unit INT_U1, the serving node being adapted for participating in a network initiated dedicated bearer modification procedure, the processing means being adapted for:

for a user entity not supporting network requested dedicated bearers;
receiving 111 an update PDP context request signal from a gateway node G with a requested QoS class;
transmitting 112 a create BSS packet flow context request or 122 a RAB assignment request signal to a radio node R.

Moreover the serving node—upon receiving a create BSS packet flow context accept 114 or a RAB assignment response signal 124 from the radio node R—refraining 115 from transmitting a modify PDP context request signal to the user entity;
is transmitting 116 an update PDP context response message with a negotiated QoS class to the gateway node.

There is also provided a radio node R comprising processing means CTRL_R; MEM_R and an interface unit INT_UR, the radio node being adapted for participating in a network requested secondary PDP context activation procedure OR for participating in a network requested dedicated bearer modification procedure;

for a user entity not supporting network requested dedicated bearers;
the radio node when receiving a create BSS packet flow context request signal 97; 122 or when receiving a RAB assignment request signal 107; 122
if an indication that the user supports no network requested dedicated bearer is available, storing 98, 108, 113, 123 the indication.

The radio node is
assigning 98, 108, 113, 123 a quality of service level on a radio link to the user entity U1 so as to substantially correspond to the quality of service of the dedicated bearer;
preventing 98, 108, 113, 123 invoking signalling towards the user entity associated with the given packet flow context 98, 113 or preventing bearer specific signalling 108, 123 towards the user entity; and is
transmitting 99; 114 a create BSS packet flow context accept to the serving node or transmitting a RAB assignment response 109; 124 signal to the serving node.

When the RAB assignment request 107 comprises an indication that the user entity supports no network requested dedicated bearer
the radio node R, may store 108 the indication that the user supports no network requested dedicated bearer.

The assignment 98, 108, 113, 123 of a quality of service level on a radio link to the user entity corresponding to the network requested dedicated bearer, further involves that the respective quality of service level QoS_A for a first downlink stream DL3 corresponds to the quality of service QoS_A of a default bearer DFT_A′ and the respective quality of service level QoS_B for a second downlink stream DL4 corresponds to the quality of service QoS_B of the network requested dedicated bearer DCT_B′.

There is also provided a serving node S comprising processing means CTRL_U1; MEM_1 and an interface unit INT_U1, the serving node being adapted for participating in a network initiated dedicated bearer deactivation procedure comprising the steps of:

for a user entity not supporting network requested dedicated bearers;
receiving 131 a delete PDP context request signal from a gateway node G;
refraining 132 from transmitting a deactivate PDP context request signal to the user entity. The serving node is further
transmitting 133 a delete PDP context response message to the gateway node;
transmitting 134 a BSS packet flow context procedure radio access bearer release signal or transmitting 144 a radio access bearer release signal to the radio node R.

Finally there is provided a radio node R comprising processing means CTRL_R; MEM_R and an interface unit INT_UR, the serving node being adapted for

for a user entity not supporting network requested dedicated bearers;
the radio node when receiving a create BSS packet flow context procedures signal 134 or a radio access bearer release signal 144;
preventing 135 invoking signalling towards the user entity U1 associated with the given packet flow context or suppressing 145 bearer related signalling with the user entity U1.

1-25. (canceled)

26. A method in a serving node for carrying out steps of a primary PDP context activation procedure, comprising:
receiving an activate PDP context request signal from a user entity for a PDP context;
determining that the user entity does not support network requested dedicated bearers; and
as a result of determining that the user entity does not support network requested dedicated bearers:
i) storing information that the user entity does not support network requested dedicated bearers; and
ii) transmitting a PDP context signal to a gateway node in which an indication that the user entity and the serving node support network requested dedicated bearers is inserted, whereby the serving node is emulating that the user entity supports network requested dedicated bearers.

27. The method according to claim 26, further comprising:
receiving a create PDP context response signal from the gateway node, with a further indication that network requested procedures will be used for the requested PDP context; and
transmitting an activate PDP context accept signal to the user entity, excluding the further indication that network requested dedicated bearers will be used for the requested PDP context.

28. A method in a serving node for carrying out steps of a network requested secondary PDP context activation procedure, comprising:
receiving an initiate PDP context activation request signal from a gateway node;
determining that the user entity does not support network requested dedicated bearers; and
as a result of determining that the user entity does not support network requested dedicated bearers:
i) transmitting an initiate PDP context activation response signal indicating the network requested secondary PDP context activation has been accepted without engaging in signalling with the user entity; and
ii) transmitting a create PDP context request signal to the gateway node.

29. The method according to claim 28, further comprising:
receiving a create PDP context response signal from the gateway node, with a negotiated quality of service; and
transmitting a create BSS packet flow context request signal to the user entity, optionally comprising an indication, that the user entity supports no network requested dedicated bearer.

30. The method according to claim 28, further comprising:
receiving a create PDP context response signal from the gateway node, with a negotiated quality of service; and
transmitting a transmit RAB assignment request signal to the user entity, comprising an indication, that the user entity supports no network requested dedicated bearer.

31. The method according to claim 30, wherein the serving node upon receiving a RAB assignment response signal or a create BSS packet flow context accept signal:
refraining from transmitting a PDP context response signal to the user entity; and
transmitting an update PDP context request signal to the gateway node.

32. A method in a radio node for carrying out steps of a network requested secondary PDP context activation procedure or for carrying out steps of a network requested dedicated bearer modification procedure, comprising:
for a user entity not supporting network requested dedicated bearers;
the radio node when receiving a create BSS packet flow context request signal or when receiving a RAB assignment request signal
if an indication that the user supports no network requested dedicated bearer is available, storing the indication;
assigning a quality of service level on a radio link to the user entity so as to substantially correspond to the quality of service of the dedicated bearer;
preventing invoking signalling towards the user entity associated with the given packet flow context or preventing bearer specific signalling towards the user entity;
transmitting a create BSS packet flow context accept to the serving node or transmitting a RAB assignment response signal to the serving node.

33. The method according to claim 32, wherein when the RAB assignment request comprises an indication that the user entity supports no network requested dedicated bearer
the radio node, storing the indication that the user supports no network requested dedicated bearer.

34. The method for a radio node according to claim 32, wherein the step of assigning a quality of service level on a radio link to the user entity corresponding to the network requested dedicated bearer, further involves that
the respective quality of service level for a first downlink stream corresponds to the quality of service of a default bearer and the respective quality of service level for a second downlink stream corresponds to the quality of service of the network requested dedicated bearer.

35. A serving node comprising processing means and an interface unit, the serving node being adapted for participating in a network requested secondary PDP context activation procedure, the processing means being adapted for:
receiving an initiate PDP context activation request signal from a gateway node;
determining whether the user entity supports network requested dedicated bearers; and if not the case;
without engaging in signalling with the user entity, transmitting an initiate PDP context activation response signal indicating the network requested secondary PDP context activation has been accepted;
transmitting a create PDP context request signal to the gateway node.

36. The serving node according to claim 35, adapted to further:
receiving a create PDP context response signal from the gateway node, with a negotiated quality of service;
transmitting a create BSS packet flow context request signal to the user entity, optionally comprising an indication, that the user entity supports no network requested dedicated bearer.

37. The serving node according to claim 35, adapted to further:
receiving a create PDP context response signal from the gateway node, with a negotiated quality of service;
transmitting a transmit RAB assignment request signal to the user entity, comprising an indication, that the user entity supports no network requested dedicated bearer.

38. The serving node according to claim 37, adapted to
upon receiving a RAB assignment response signal or a create BSS packet flow context accept signal;
refraining from transmitting a PDP context response signal to the user entity;
transmitting an update PDP context request signal to the gateway node.
